(19) United States
(12) Patent Application Publication
(10) Pub. No.: US 2019/0047763 A1
(43) Pub. Date: Feb. 14, 2019

(54) Carrier for Containers

(71) Applicant: Graphic Packaging International, LLC, Atlanta, GA (US)

(72) Inventor: John Murdick Holley, JR., Lawrenceville, GA (US)

(21) Appl. No.: 16/045,939

(22) Filed: Jul. 26, 2018

Related U.S. Application Data
(60) Provisional application No. 62/543,053, filed on Aug. 9, 2017.

(51) Int. Cl. B65D 71/24; B31B 50/26

(52) U.S. Cl. CPC B65D 71/243; B31B 50/26; B65D 2571/0066; B65D 2571/00388; B65D 2571/00141

(57) ABSTRACT

A carrier for holding at least one container includes a plurality of panels extending at least partially around an interior of the carrier, the plurality of panels includes a front panel, a back panel, at least one central panel, at least one side panel, and at least one bottom panel. At least one divider flap is foldably connected to one of the front panel and the back panel, the at least one divider flap folded away from the one of the front panel and the back panel to form at least one opening in the one of the front panel and the back panel, the at least one divider flap extends through the interior of the carrier to the at least one central panel.

### CROSS-REFERENCE TO RELATED APPLICATION

This application claims the benefit of U.S. Provisional Patent Application No. 62/543,053, filed on Aug. 9, 2017.

### INCORPORATION BY REFERENCE

The disclosure of U.S. Provisional Patent Application No. 62/543,053, filed on Aug. 9, 2017, is hereby incorporated by reference for all purposes as if presented herein in its entirety.

### BACKGROUND OF THE DISCLOSURE

The present disclosure generally relates to carriers or cartons for holding and displaying containers. More specifically, the present disclosure relates to carriers that can be inserted into an outer carton.

### SUMMARY OF THE DISCLOSURE

According to one aspect of the disclosure, a carrier for holding at least one container comprises a plurality of panels extending at least partially around an interior of the carrier, the plurality of panels comprising a front panel, a back panel, at least one central panel, at least one side panel, and at least one bottom panel. The carrier further comprises at least one divider flap foldably connected to one of the front panel and the back panel, the at least one divider flap folded away from the one of the front panel and the back panel to form at least one opening in the one of the front panel and the back panel, the at least one divider flap extends through the interior of the carrier to the at least one central panel.

According to another aspect of the disclosure, a blank for forming a carrier for holding at least one container comprises a plurality of panels for extending at least partially around an interior of the carrier formed from the blank, the plurality of panels comprising a front panel, a back panel, at least one central panel, at least one side panel, and at least one bottom panel. The blank further comprises at least one divider flap foldably connected to one of the front panel and the back panel, the at least one divider flap is for being folded away from the one of the front panel and the back panel to form at least one opening in the one of the front panel and the back panel in the carrier formed from the blank, the at least one divider flap extends through the interior of the carrier formed from the blank to the at least one central panel.

According to another aspect of the disclosure, a method of forming a carrier for holding at least one container comprises obtaining a blank comprising a plurality of panels, the plurality of panels comprising a front panel, a back panel, at least one central panel, at least one side panel, and at least one bottom panel, the blank further comprising at least one divider flap foldably connected to one of the front panel and the back panel. The method further comprises folding the plurality of panels at least partially around an interior of the blank, and the method further comprises folding the at least one divider flap away from the one of the front panel and the back panel to form at least one opening in the one of the front panel and the back panel and such that the at least one divider flap extends through the interior of the carrier to the at least one central panel.

According to another aspect of the disclosure, a system comprises a first carrier and a second carrier. The first carrier comprises a plurality of panels extending at least partially around an interior of the first carrier, the plurality of panels comprising a front panel, a back panel, at least one central panel, at least one side panel, and at least one bottom panel. The first carrier further comprises at least one divider flap foldably connected to one of the front panel and the back panel, the at least one divider flap folded away from the one of the front panel and the back panel to form at least one opening in the one of the front panel and the back panel, the at least one divider flap extends through the interior of the first carrier to the at least one central panel. The second carrier comprises a plurality of panels extending at least partially around an interior of the second carrier, at least one panel of the plurality of panels of the second carrier is positioned adjacent the one of the front panel and the back panel of the first carrier to cover the at least one opening of the first carrier.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an outer surface of a blank for forming a carrier according to an exemplary embodiment of the disclosure.

FIG. 2 is a first sequential perspective view of a partial folding of the blank of FIG. 1 according to an exemplary embodiment of the disclosure.

FIG. 3 is a second sequential perspective view of a partial folding of the blank of FIG. 1 according to an exemplary embodiment of the disclosure.

FIG. 4 is a third sequential perspective view of a partial folding of the blank of FIG. 1 according to an exemplary embodiment of the disclosure.

FIG. 5 is a plan view of a carton formed from the blank of FIG. 1 in a folded configuration according to an exemplary embodiment of the disclosure.

FIG. 6 is a plan view of the carton in the folded configuration of FIG. 5 and viewed from an opposite side.

FIG. 7 is a perspective view of a partial movement of the carton in the folded configuration of FIGS. 5 and 6 toward an erected configuration.

FIG. 8 is a schematic side view of the carton of FIG. 7 being partially moved further toward an erected configuration of the carton.

FIG. 9 is a plan view of the carton in the folded configuration of FIG. 5 according to an alternative exemplary embodiment of the disclosure.

FIG. 10 is a perspective view of the carton of FIGS. 5 and 6 in an erected configuration.

FIG. 11 is a perspective view of the carton of FIG. 10 loaded with a plurality of containers.

FIG. 12 is a perspective view of a system including a pair of the carriers of FIG. 11 in a side-by-side arrangement according to an exemplary embodiment of the disclosure.

FIG. 13 is a perspective view of the system of FIG. 12 being loaded into an outer container.

Corresponding parts are designated by corresponding reference numbers throughout the drawings.

### DETAILED DESCRIPTION OF THE EXEMPLARY EMBODIMENTS

The present disclosure generally relates to carriers, packages, constructs, sleeves, cartons, or the like, for holding and displaying containers such as jars, bottles, cans, etc. The containers can be used for packaging food and beverage products, for example. The containers can be made from materials suitable in composition for packaging the particular food or beverage item, and the materials include, but are not limited to, glass; plastics such as PET, LDPE, LLDPE, HDPE, PP, PS, PVC, EVOH, and Nylon; and the like; aluminum and/or other metals; or any combination thereof.

Carriers according to the present disclosure can accommodate containers of numerous different shapes. For the purpose of illustration and not for the purpose of limiting the scope of the disclosure, the following detailed description describes beverage containers (e.g., glass bottles) at least partially disposed within the carrier embodiments. In this specification, the terms “lower,” “bottom,” “upper,” “top,” “front,” and “back” indicate orientations determined in relation to fully erected carriers.

As described herein, carriers may be formed by multiple overlapping panels, end flaps, and/or other portions of blanks. Such panels, end flaps, and/or other portions of the blank can be designated in relative terms to one another, e.g., “first”, “second”, “third”, etc., in sequential or non-sequential reference, without departing from the disclosure.

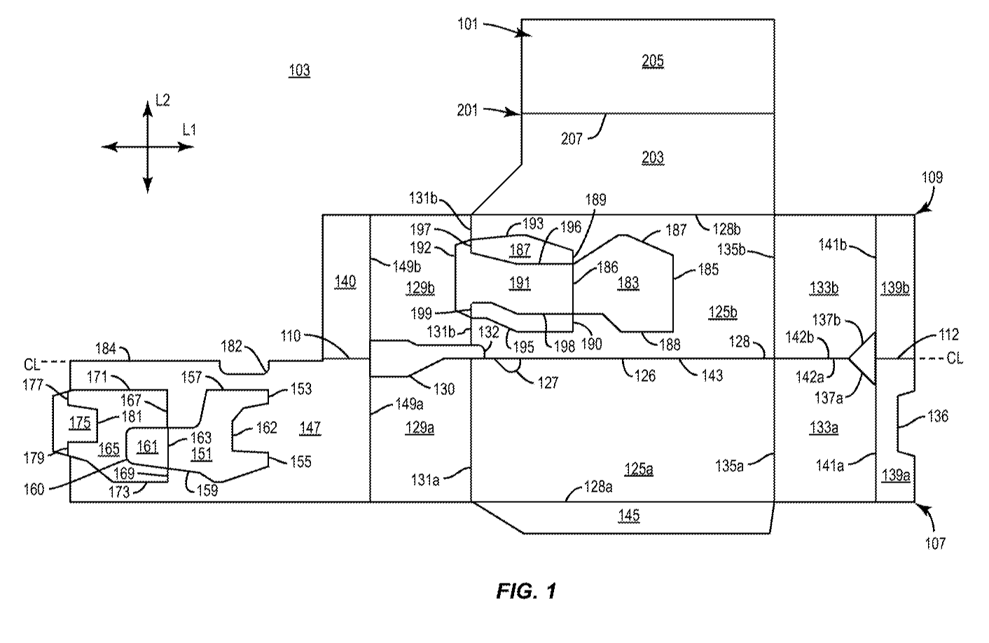

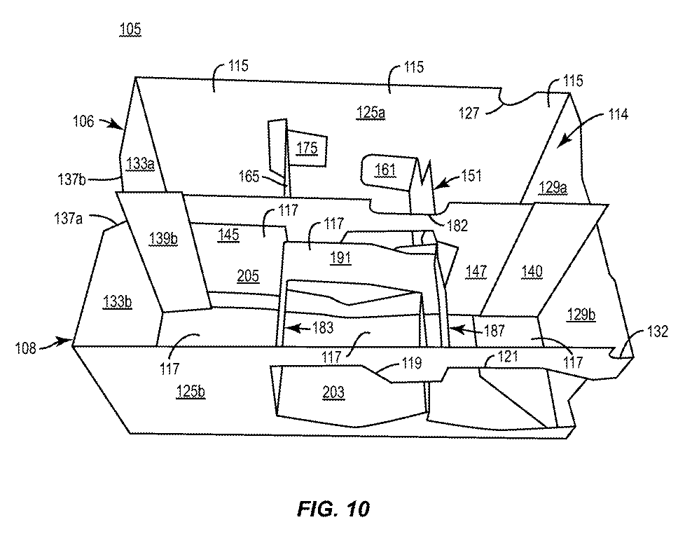

FIG. 1 shows a plan view of an exterior side 101 of a blank 103 used to form a package or carrier 105 (FIG. 10) in accordance with a first exemplary embodiment of the disclosure. As shown in FIG. 10, the carrier 105 is sized to contain six containers C, three containers C being contained in a front portion 106 of the carrier 105 and three containers C being contained in a back portion 108 of the carrier 105. In the illustrated embodiment, the containers C can be beverage bottles, but the containers C could be any other suitable type and size of container without departing from the disclosure. The carrier 105 can be sized and shaped to hold more or less than six containers C. In one embodiment, the front portion 106 and the back portion 108 of the carrier 105 each have three containers C. In other embodiments, the front portion 106 and the back portion 108 of the carrier 105 can hold more or less than three containers C without departing from the disclosure.

As shown in FIG. 1, the blank 103 has a longitudinal axis L1 and a lateral axis L2. The blank 103 has a front portion 107 for forming the front portion 106 of the carrier 105 (FIG. 10), and a back portion 109 for forming the back portion 108 of the carrier 105 (FIG. 10). In one embodiment, the front portion 107 and the back portion 109 are separated at a longitudinal centerline CL of the blank 103, as shown. As discussed in more detail below, the blank 103 is formed into the carrier 105 by folding the blank 103 about fold lines 110, 112 along the centerline CL so that the front portion 107 and the back portion 109 of the blank 103 are overlapped in at least partial face-to-face contact.

In the illustrated embodiment, the front portion 107 of the blank 103 comprises a front panel 125a having a notch 127 (broadly, “first notch”) at an upper edge 126 of the front panel 125a defined by a cut 143 and that extends downwardly from an upper edge thereof and a first side panel 129a (broadly, “first front side panel”) foldably connected to the front panel 125a at a lateral fold line 131a. As shown, an upper portion of the first side panel 129a defines a notch or downwardly-extending edge 130 of the first side panel 129a that can include one or more angled and/or curved portions. A second side panel 133a (broadly, “second front side panel”), as shown, is foldably connected to the front panel 125a at a lateral fold line 135a, and includes a notch or chamfer 137a at the upper edge 142a thereof. While the chamfer 137a is illustrated as linear, it will be understood that the chamfer 137a can be angled or curved without departing from the disclosure. A keel 139a, as shown, is foldably connected to the second side panel 133a at a lateral fold line 141a that is interrupted by the chamfer 137a of the second side panel 133a. The keel 139a can include a notched or recessed portion 136 along a free edge thereof. As shown, the front panel 125a and the first side panel 129a are separated from the back portion 109 of the blank 103 along the longitudinally-extending cut 143. As also shown, the notch 127 of the front panel 125a can be a recessed portion of the front panel 125a that is disposed between portions of the cut 143. The front portion 107 of the blank 103, as shown in FIG. 1, also includes a front bottom flap 145 foldably connected to the front panel 125a at a lateral fold line 128a.

As shown in FIG. 1, the front portion 107 of the blank 103 also includes a central panel 147 foldably connected to the first side panel 129a at a lateral fold line 149a. The illustrated central panel 147 includes a first divider flap 151 (broadly, “third divider flap” or “fourth divider flap”) that is foldably connected to the central panel 147 at lateral fold lines 153, 155 and which is at least partially separable from the central panel 147 at lines of weakening 157, 159 that each may include one or more curved and/or angled portions and which extend from the respective fold lines 153, 155 to intersect a generally lateral line of weakening 160 that extends from the line of weakening 157 to the line of weakening 159. A line of weakening 162 also extends from the fold line 153 to the fold line 155 to facilitate at least partial separation of the divider flap 151 from the central panel 147, and can include one or more curved or angled portions. An attachment flap 161, as shown, is foldably connected to the first divider flap 151a at a lateral fold line 163 and is separable from the remainder of the central panel 147 at one or more portions of one or more of the lines of weakening 157, 159, 160. The central panel 147, as shown, also includes a second divider flap 165 (broadly, “third divider flap” or “fourth divider flap”) that is foldably connected to the central panel 147 at lateral fold lines 167, 169 and which is at least partially separable from the central panel 147a at lines of weakening 171, 173 that extend from the respective fold lines 167, 169 to a free edge of the central panel 147, each of which may include one or more curved and/or angled portions. The divider flap 165 is also at least partially separable from the attachment flap 161 along a portion of one or more of the lines of weakening 157, 159, 160. An attachment flap 175, as shown, is foldably connected to a marginal portion of the second divider flap 165 at lateral fold lines 177, 179 and is separable from a portion of the second divider flap 165 along a line of weakening 181 that extends from the fold line 177 to the fold line 179 and can include one or more curved and/or angled portions. The attachment flap 175 can protrude past the free edge of the central panel 147, as shown, or can have a different configuration without departing from the disclosure. As shown, the central panel 147 also includes a notch 182 (broadly, “third notch”) at an upper edge 184 thereof. As described herein, the notch 182 of the central panel 147 cooperates with the notch 127 of the front panel 125a during folding operations of the blank 103. The central panel 147 could be otherwise shaped, arranged, and/or configured, and could have other features, without departing from the disclosure.

In the illustrated embodiment, the back portion 109 of the blank 103 includes a back panel 125b, a first side panel 129b (broadly “first back side panel”), a second side panel 133b (broadly, “second back side panel”), and a keel 139b having associated features that are generally a mirror-image of the corresponding panels and flaps of the front portion 107 of the blank 103. Corresponding components (e.g., panels, flaps, fold lines, cuts, etc.) have been designated by corresponding reference numbers that differ by the “a” or “b” suffix, with the “a” components corresponding to the front portion 107 of the blank 103 and the “b” components corresponding to the back portion 109 of the blank 103. The keel 139b, as shown, can be devoid of the recessed portion 136 of the keel 139a, or can have a different configuration without departing from the disclosure.

As shown in FIG. 1, and in contrast to the front portion 107, the back portion 109 of the blank 103 includes a second keel 140 foldably connected to the second side panel 133b at the fold line 149b that is at least partially coextensive with the central panel 147 such that the keel 139b is a first keel of the back portion 109 of the blank 103. The back portion 109 of the blank 103, as shown, also defines a notch 132 (broadly, “second notch”) at an upper edge 128 of the back panel 125b which extends into and at least partially defines an upper edge of the side panel 129b. Further, the back panel 125b includes a first divider flap 183 (broadly, “first divider flap” or “second divider flap”) that is foldably connected to the back panel 125b at a lateral fold line 185 and which is separable from the back panel 125b at lines of weakening 187, 188 that each extend from the fold line 185 to lateral fold lines 189, 190. Either or both of the lines of weakening 187, 188 can have one or more curved and/or angled portions. An attachment flap 191 is foldably connected to the first divider flap 183 at a lateral fold line 186 that extends from the line of weakening 187 to the line of weakening 188, as shown, and extends into a portion of the first side panel 129b. A second divider flap 187 (broadly, “first divider flap” or “second divider flap”), as shown, is foldably connected to the back panel 125b at lateral fold lines 189, 190 that intersect the fold line 186, and is separable from the back panel 125b at lines of weakening 193, 195 each of which may have one or more curved and/or angled portions, that interrupt the fold line 131b and extend from the respective fold lines 189, 190 into a portion of the first side panel 129b. The attachment flap 191 is foldably connected to the second side panel 133b at lateral fold lines 197, 199 that intersect respective portions of the fold line 131b, and is at least partially separable from the divider flap 187 at generally longitudinally-extending lines of weakening 196, 198 that extend from the respective fold lines 189, 190 to respective portions of the fold line 131b. The attachment flap 191 is also at least partially separable from the side panel 129b at portions of the lines of weakening 193, 195 and at a lateral line of weakening 192 that extends from the line of weakening 193 to the line of weakening 195. In this regard, the attachment flap 191 interconnects the first divider flap 183 and the second divider flap 187. As also shown, the back portion 109 of the blank 103 includes a bottom panel 201 foldably connected to the back panel 125b at the fold line 128b and which includes a proximal portion 203 and a distal portion 205 foldably connected to the proximal portion 203 at a longitudinal fold line 207.

Any of the panels, flaps, fold lines, cuts, or other features could be otherwise shaped, arranged, and/or omitted from the blank 103 without departing from the disclosure. In one embodiment, an additional central panel for positioning in at least partial face-to-face contact with the central panel 147 could be provided on the blank 103. The blank 103 could be sized and/or shaped to accommodate more or less than six containers without departing from this disclosure.

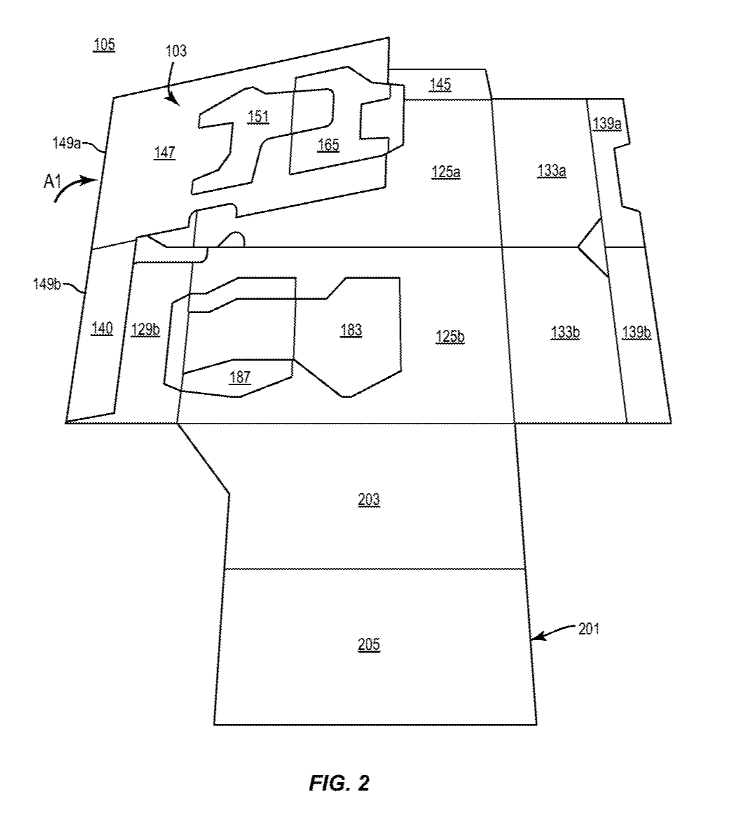

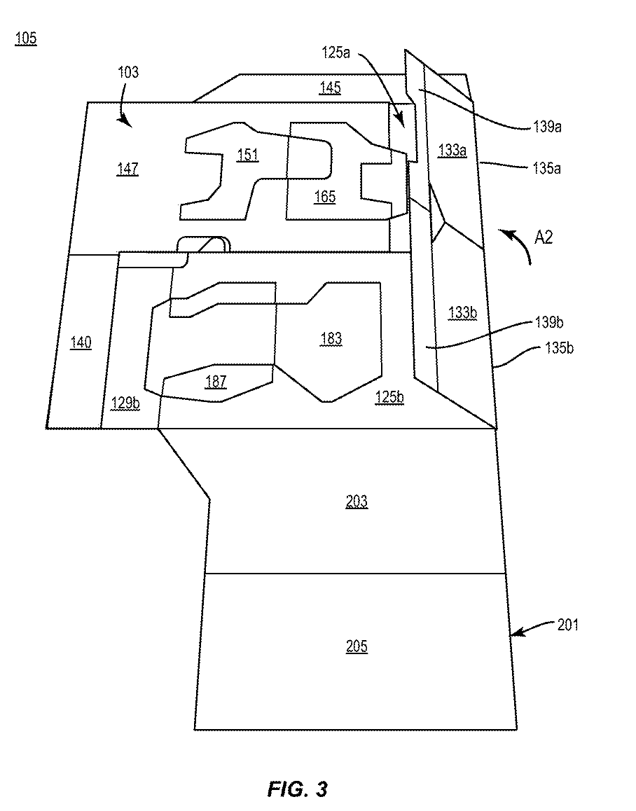

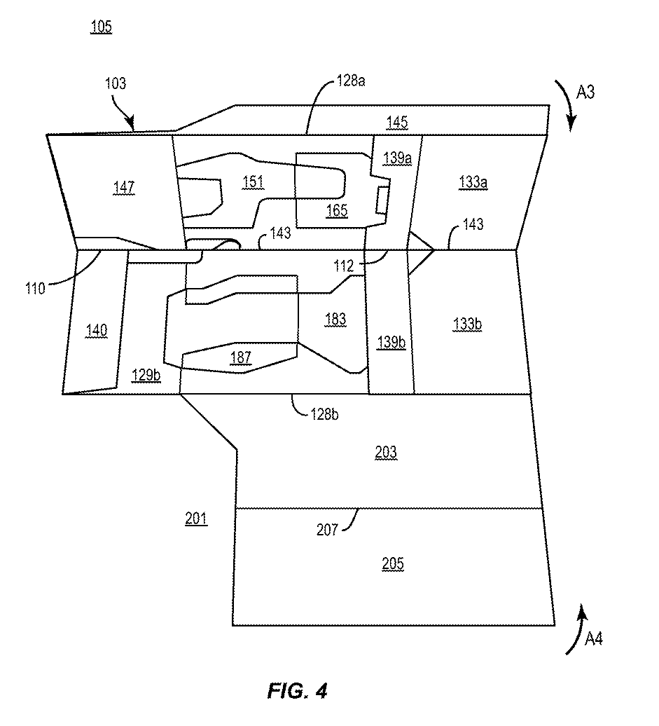

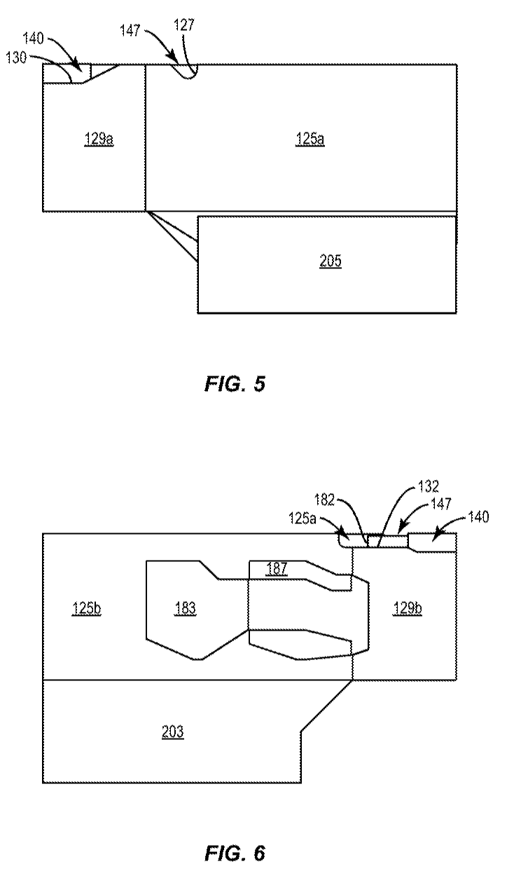

Still referring to FIG. 1, and referring additionally to FIGS. 2-6, assembly of the blank 103 into the carrier 105 (FIG. 10) is illustrated according to one exemplary embodiment of the disclosure. As shown, the carrier 105 can be erected from the blank 103 by folding the central panel 147 and the second keel 140 at the respective fold lines 149a, 149b in the direction of the arrow A1 such that the central panel 147 is in at least partial face-to-face contact with the first side panel 129a and the front panel 125a and such that the second keel 140 is in at least partial face-to-face contact with the first side panel 129b.

The second side panels 133a, 133b can then be folded at the respective fold lines 135a, 135b in the direction of the arrow A2 such that the second side panel 133a is in at least partial face-to-face contact with a portion of the front panel 125a and a portion of the central panel 147, the keel 139a is in at least partial face-to-face contact with the central panel 147, the second side panel 133b is in at least partial face-to-face contact with the back panel 125b, and the keel 139b is in at least partial face-to-face contact with the back panel 125b.

The central panel 147 can then be folded at the fold line 110 and the keel 139a can then be folded at the fold line 112 in the direction of the arrow A3 such that the central panel 147 is in at least partial face-to-face contact with the second keel 140 and a portion of the back panel 125b, the second side panel 133a is in at least partial face-to-face contact with the second side panel 133b, and the keel 139a is in at least partial face-to-face contact with the keel 139b. In such a configuration, the attachment flaps 161, 175 of the respective first and second divider flaps 151, 165 can be secured in at least partial face-to-face contact with the front panel 125a and the attachment flap 191 of the first and second divider flaps 183, 187 can be secured in at least partial face-to-face contact with portions of the central panel 147. The attachment flaps 161, 185, 191 can be secured in the above-described positions with an adhesive such as glue. The distal portion 205 of the bottom panel 201 can also be folded at the fold line 207 in the direction of the arrow A4 into at least partial face-to-face contact with the bottom flap 145. As described above, any of the panels and/or flaps of the blank 103 may be treated, for example, with an adhesive such as glue, to facilitate securing and contact of panels and/or flaps to one another in the course of forming the carrier 105. Folding of the blank 103 into the carrier 105 can be performed with different and/or differently-ordered steps without departing from the disclosure.

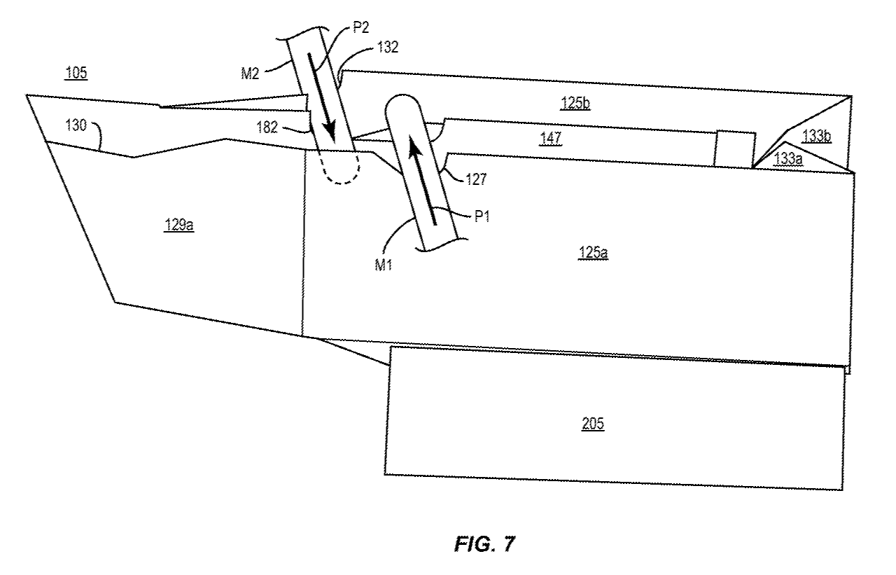

Referring to FIGS. 6-8, the folded configuration of the carrier 105 formed from the blank 103 as described above is illustrated. In the folded configuration of the carrier 105 shown, the notch 127 of the front panel 125a and the notch 182 of the central panel 147 are aligned, e.g., in at least partial overlapping relation along the longitudinal axis L1 (FIG. 1), such that the notch 127 provides an access path P1 (broadly, “first access path”) from the front panel 125a to a portion of the central panel 147 that is aligned with the notch 127, e.g., the notch 182. Accordingly, in the folded configuration of the carrier 105, the access path P1 provides access through the notch 127, past the central panel 147 through the notch 182, and to a portion of the back panel 125b that is aligned with the notches 127, 182. In this regard, in the folded configuration shown, the notches 127, 182 provide the access path P1 for a machine component M1, for example, an actuator, finger, rod, pusher, and/or suction device, to name a few, to contact the back panel 125b and urge the back panel 125b away from the front panel 125a and the central panel 147 in the course of forming the carrier 105. Similarly, the notch 132 of the back panel 129b is aligned with a portion of the central panel 147, e.g., the notch 182. Accordingly, in the folded configuration of the carrier 105, the notch 132 of the back panel 125b and the notch 182 of the central panel 147 are aligned such that the notches 132, 182 provide an access path P2 (broadly, “second access path”) from the back panel 125b, past the central panel 147 through the notch 182, and to a portion of the front panel 125a that is aligned with the notches 132, 182 such that a machine component M2, which can be substantially similar to machine component M1, can contact the front panel 125b through the notches 132, 182 and urge the front panel 125a away from the back panel 125b and the central panel 147 in the course of forming the carrier 105. In one embodiment, a manual operator can effect relative movement of one or more portions of the carrier 105 via the access paths P1, P2. In one embodiment, either of the machine components M1, M2 can be passed through either of the access paths P1, P2 described herein. It will be understood that the actions of the machine components M1, M2 can be performed in any sequence, or in tandem, without departing from the disclosure.

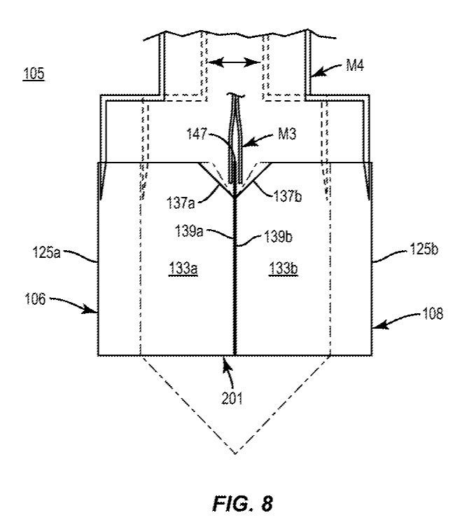

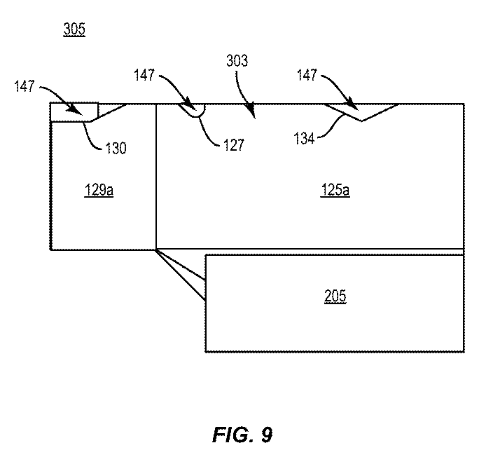

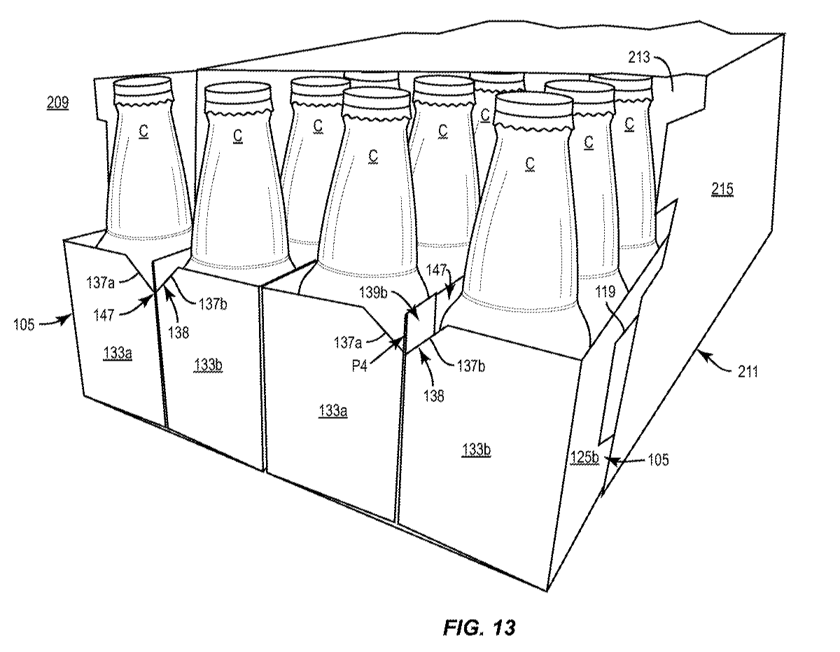

Referring additionally to FIG. 8, prior to, during, and/or following the urging of the back panel 125b through the notches 127, 182 and/or the urging of the front panel 125a through the notches 132, 182 as described above, one or more portions of the central panel 147 of the folded configuration of the carrier 105 can be grasped by a guide M3, which can be a machine component such as a clamp, grasper, pincer, and/or suction device, to name a few. In one embodiment, the guide M3 can engage portions of the central panel 147 and/or a portion of the keels 139a, 139b from above the carrier 105. In another embodiment, the guide M3 can laterally engage portions of the central panel 147 and/or a portion of the keels 139a, 139b, 140 through recessed portions of the front and/or back panels 125a, 125b at which the central panel 147 is exposed, for example, the notches 127 and/or 132. The guide M3 can also engage portions of the central panel 147 and/or a portion of the keels 139a, 139b, 140 at portions thereof exposed above or through the panels 125a, 125b, 129a, 129b, 133a, 133b. For example, as the folded configuration of the carrier 105 is formed into the erected configuration of the carrier 105, each of the chamfers 137a, 137b of the respective second side panels 133a, 133b are adjacent the central panel 147 and the keels 139a, 139b such that each of the chamfers 137a, 137b, at least partially form a notch or recess 138 above or through which the central panel 147 and/or a portion of the keels 139a, 139b are exposed such that they can be grasped by the guide M3 or another machine component through an access path P4 (broadly, “fourth access path”) (FIG. 13). As also shown, a machine component M4 can then be inserted between the central panel 147 and/or a portion of the keels 139a, 139b, 140 and one or both of the front panel 125a and the back panel 125b and moved outwardly to further space apart the front panel 125a, the central panel 125b, and the back panel 125b and transition the folded configuration of the carrier 105 into the erected configuration of the carrier 105. The machine component M4, as shown, can be a forked device or pair of arms actuatable to move the front and/or back panels 125a, 125b away from one another. The machine component M4 can have a different configuration without departing from the disclosure.

Referring momentarily to FIG. 9, a blank according to an alternative embodiment of the disclosure is generally designated 303 and shown in a folded configuration of a carrier 305 similar to that of the blank 103 (FIG. 1) and the carrier 105 described above. The blank 303/carrier 305 is substantially similar to the blank 103/carrier 105 described above, but includes an additional notch 134 (broadly, “fourth notch”) at the upper edge 126 of the front panel 125a that provides an access path P3 (broadly, “third access path”) to a portion of the central panel 147 through which the central panel 147 can be grasped by a guide such as M3 (FIG. 8) during formation of the carrier 305. In one embodiment, one or both of the machine components M1, M2 can follow the access path P3 to engage a portion of the central panel 147. Blanks and carriers can include additional or alternative notches along portions thereof to facilitate folding and forming of a carrier without departing from the disclosure.

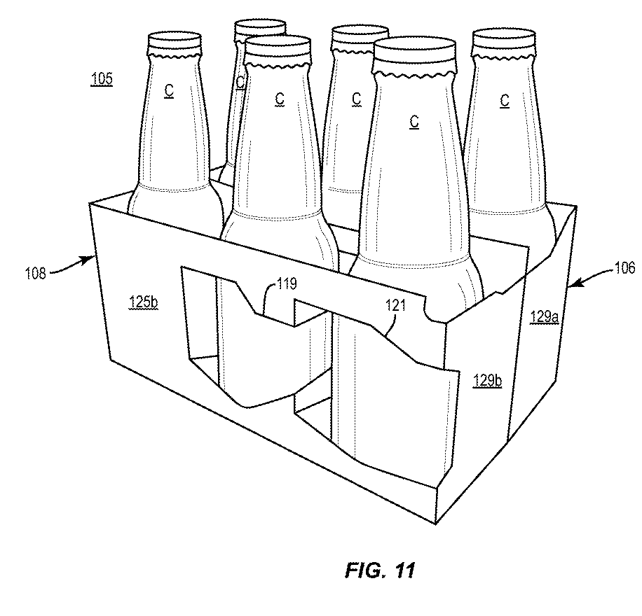

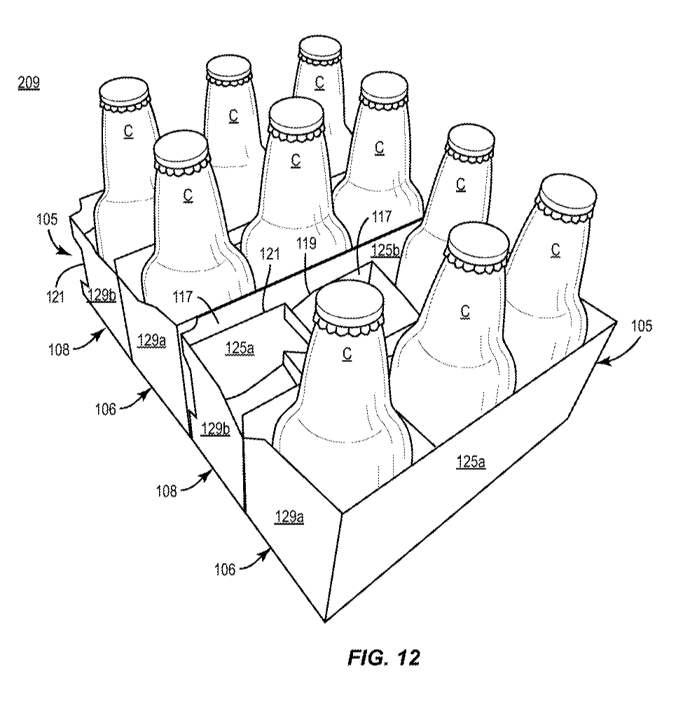

Referring again to FIG. 1, and turning to FIGS. 10 and 11, the erected configuration of the carrier 105 is thus formed by arranging the front panel 125a, the central panel 147, and the back panel 125b in parallel spaced relation, with the first side panel 129a and the second side panel 133a extending from the front panel 125a to the central panel 147 and the first side panel 129b and the second side panel 133b extending from the back panel 125b to the central panel 147, such that an interior 114 of the carrier 105 is defined. Formation of the carrier 105 in such an arrangement also results in at least partial separation of the first divider flap 151 from the central panel 147 and the second divider flap 165 at the lines of weakening 157, 159, 160, 162 and at least partial separation of the second divider flap 165 from the central panel 147 and the first divider flap 151 at the lines of weakening 171, 173, 157, 159, 160. The attachment flap 161 is at least partially separated from the second divider panel 165 at portions of the lines of weakening 157, 159, 160, the attachment flap 175 is at least partially separated from the second divider flap 165 at the line of weakening 181, and the attachment flaps 161, 175 are folded at the respective fold lines 163 and 177, 179 to be positioned in at least partial face-to-face contact with the front panel 125a.

Upon the aforementioned formation of the carrier 105, the first divider flap 183 is at least partially separated from the back panel 125b and the second divider flap 187 at the lines of weakening 178, 188, 196, 198 and the second divider flap 187 is at least partially separated from the back panel 125b, the first divider flap 183, and the side panel 129b at the lines of weakening 193, 195, 192. The attachment flap 191 is separated from the second divider flap 187 at the lines of weakening 196, 198 and the line of weakening 192, and the attachment flap 191 is folded at the fold lines 186, 197, 199 to be positioned in at least partial face-to-face contact with the central panel 147. In this regard, the divider flaps 151, 165 extend from the central panel 147 to the front panel 125a via the interior 114 of the carrier 105 and are attached to the front panel 125a with the attachment flaps 161, 175, and the divider flaps 183, 187 extend from the back panel 125b to the central panel 147 through the interior 114 of the carrier 105 and are attached to the central panel 147 via the attachment flap 191. In such an arrangement, three container-receiving spaces 115 are defined in the interior 114 of the carrier 105 in the front portion 106 of the carrier 105 and three container-receiving spaces 117 are defined in the interior 114 of the carrier 105 in the back portion 108 of the carrier 105.

Turning to FIG. 11, the carrier 105 is shown loaded with containers C in the container-receiving spaces 115, 117, for example, manually or with a loading apparatus. As shown, the portions of the back panel 125b from which the divider flaps 183, 187 are separated and folded away from form openings or windows 119 (broadly, “first opening” or “second opening”), 121 (broadly, “first opening” or “second opening”) to provide access into the container-receiving spaces 117 in the interior 114 of the carrier 105. The windows 119, 121 are discontinuities and/or voids in the back panel 125b such that the amount of material that forms the carrier 105 is reduced or optimized, for example, as compared to a carrier having panels that lack such windows. Additionally or alternatively, the windows 119, 121 can provide visibility to customers of a label or other portion of containers C disposed in the container-receiving spaces 117 for the purpose of conveying product information. The windows 119, 121 can also provide regions for inspection of the containers C, for example, to identify defects or for quality control, for example, prior to shipping, following shipping, and/or prior to placement of the carrier 105 in a retail location. It will be understood that the carrier 105 can include additional or fewer or windows, or a different arrangement of windows, without departing from the disclosure. For example, in one embodiment, windows 119, 121 can additionally or alternatively be provided on the front panel 125a.

Turning additionally to FIG. 12, the carriers 105 loaded with the containers C can be arranged for storage and/or transport as a carrier or insert system 209 that includes at least two carriers 105 in an abutting or side-by-side arrangement with a front panel 125a of one carrier 105 (broadly, “second carrier”) in at least partial face-to-face contact with the back panel 125b of an adjacent carrier 105 (broadly, “first carrier”), as shown. In this regard, the windows 119, 121 in the back panel 125b of the first carrier 105 of the system 209 are covered, e.g., in at least partial face-to-face contact, by the front panel 125a of the adjacent second carrier 105 of the system 209 such that each front panel 125a, which is substantially devoid of windows or other openings, is shared by adjacent first and second carriers 105 in the system 209 to provide enhanced coverage and protection of containers C in the carriers 105, while allowing portions of the carriers 105 to retain windows 119, 121 for material-saving purposes and/or product visibility. While the system 209 is illustrated with two carriers 105, it will be understood that the system 209 can include greater than two carriers 105.

Referring additionally to FIG. 13, the system 209 can be used with an outer container or outer carton 211 having an interior 213 within which the two or more adjacent carriers 105 can be inserted in the side-by-side configuration described above. In this regard, the system 209 of carriers 105 can be inserted into the interior 213 of the outer carton 211, for example, manually or through the use of a conveyer or other transporting apparatus. In one embodiment, the notch 138 near the second side panels 129a, 129b can provide access to the second keel 140 and/or the central panel 147 to facilitate loading of the carriers 105 into the outer carton 211. In one embodiment, the system 209 includes the outer carton 211. It will be understood that one carrier 105 of the system 209 can have respective windows 119, 121 positioned in at least partial face to face contact with a side 215 of the outer carton 211 such that the side 215 of the outer carton 211 covers the windows 119, 121 for protection and/or visibility therethrough as described above.

In general, the blank may be constructed from paperboard having a caliper so that it is heavier and more rigid than ordinary paper. The blank can also be constructed of other materials, such as cardboard, or any other material having properties suitable for enabling the carrier to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carrier for holding at least one container, the carrier comprising:
a plurality of panels extending at least partially around an interior of the carrier, the plurality of panels comprising a front panel, a back panel, at least one central panel, at least one side panel, and at least one bottom panel;
at least one divider flap foldably connected to one of the front panel and the back panel, the at least one divider flap folded away from the one of the front panel and the back panel to form at least one opening in the one of the front panel and the back panel, the at least one divider flap extends through the interior of the carrier to the at least one central panel.

2. The carrier of claim 1, wherein the at least one opening provides access to the interior of the carrier.

3. The carrier of claim 1, wherein the at least one opening extends at least partially into the at least one side panel.

4. The carrier of claim 1, wherein the at least one divider flap is a first divider flap and the carrier further comprises a second divider flap foldably connected to the one of the front panel and the back panel, the second divider flap extends from the one of the front panel and the back panel to the at least one central panel, the at least one opening is a first opening, and the second divider flap is folded away from the one of the front panel and the back panel to form a second opening in the one of the front panel and the back panel.

5. The carrier of claim 4, wherein the first opening is in communication with the second opening.

6. The carrier of claim 5, wherein an attachment flap is foldably connected to each of the first divider flap and the second divider flap.

7. The carrier of claim 1, wherein the at least one side panel is a first front side panel and the plurality of panels further comprises a second front side panel, a first back side panel, and a second back side panel.

8. The carrier of claim 7, wherein the at least one divider flap is a first divider flap foldably connected to the back panel and the carrier further comprises a second divider flap foldably connected to the back panel and extending to the at least one central panel, the carrier further comprises a third divider flap and a fourth divider flap each foldably connected to the at least one central panel and extending to the front panel.

9. The carrier of claim 1, wherein at least one of the front panel and the back panel comprises at least one notch at an upper edge thereof, the at least one notch provides an access path to a portion of the at least one central panel aligned with the at least one notch.

10. The carrier of claim 9, wherein the at least one notch is a first notch at an upper edge of the front panel and the access path is a first access path, and the back panel comprises a second notch at an upper edge thereof that provides a second access path to a portion of the at least one central panel aligned with the second notch.

11. The carrier of claim 10, wherein the at least one central panel comprises a third notch at an upper edge thereof, and wherein in a folded configuration of the carrier, the first notch and the third notch are aligned such that the first access path extends through the third notch to a portion of the back panel.

12. The carrier of claim 11, wherein in the folded configuration of the carrier, the second notch and the third notch are aligned such that the second access path extends through the third notch to a portion of the front panel.

13. The carrier of claim 11, wherein the front panel comprises a fourth notch at an upper edge thereof, wherein in the folded configuration of the carrier the fourth notch provides a fourth access path to a portion of the central panel aligned with the fourth notch.

14. The carrier of claim 11, wherein the at least one side panel comprises a chamfer at an upper edge thereof, the chamfer is adjacent the at least one central panel such that the at least one central panel is exposed above the chamfer.

15. A blank for forming a carrier for holding at least one container, the blank comprising:
a plurality of panels for extending at least partially around an interior of the carrier formed from the blank, the plurality of panels comprising a front panel, a back panel, at least one central panel, at least one side panel, and at least one bottom panel,
the blank further comprising at least one divider flap foldably connected to one of the front panel and the back panel,
the at least one divider flap is for being folded away from the one of the front panel and the back panel to form at least one opening in the one of the front panel and the back panel in the carrier formed from the blank, the at least one divider flap extends through the interior of the carrier formed from the blank to the at least one central panel.

16. The blank of claim 15, wherein the at least one opening provides access to the interior of the carrier formed from the blank.

17. The blank of claim 15, wherein the at least one opening extends at least partially into the at least one side panel in the carrier formed from the blank.

18. The blank of claim 15, wherein the at least one divider flap is a first divider flap and the blank further comprises a second divider flap foldably connected to the one of the front panel and the back panel, the second divider flap extends from the one of the front panel and the back panel to the at least one central panel in the carrier formed from the blank, the at least one opening is a first opening in the carrier formed from the blank, and the second divider flap is folded away from the one of the front panel and the back panel to form a second opening in the one of the front panel and the back panel in the carrier formed from the blank.

19. The blank of claim 18, wherein the first opening is in communication with the second opening in the carrier formed from the blank.

20. The blank of claim 19, wherein an attachment flap is foldably connected to each of the first divider flap and the second divider flap.

21. The blank of claim 15, wherein the at least one side panel is a first front side panel and the plurality of panels further comprises a second front side panel, a first back side panel, and a second back side panel.

22. The blank of claim 21, wherein the at least one divider flap is a first divider flap foldably connected to the back panel and the blank further comprises a second divider flap foldably connected to the back panel, the blank further comprises a third divider flap and a fourth divider flap each foldably connected to the at least one central panel.

23. The blank of claim 15, wherein at least one of the front panel and the back panel comprises at least one notch at an upper edge thereof, the at least one notch provides an access path to a portion of the at least one central panel aligned with the at least one notch in the carrier formed from the blank.

24. The blank of claim 23, wherein the at least one notch is a first notch at an upper edge of the front panel and the access path is a first access path in the carrier formed from the blank, and the back panel comprises a second notch at an upper edge thereof that provides a second access path to a portion of the at least one central panel aligned with the second notch in the carrier formed from the blank.

25. The blank of claim 24, wherein the at least one central panel comprises a third notch at an upper edge thereof, and wherein in a folded configuration of the carrier formed from the blank, the first notch and the third notch are aligned such that the first access path extends through the third notch to a portion of the back panel.

26. The blank of claim 25, wherein in the folded configuration of the carrier formed from the blank, the second notch and the third notch are aligned such that the second access path extends through the third notch to a portion of the front panel.

27. The blank of claim 25, wherein the front panel comprises a fourth notch at an upper edge thereof, wherein in the folded configuration of the carrier formed from the blank the fourth notch provides a fourth access path to a portion of the central panel aligned with the fourth notch.

28. The blank of claim 25, wherein the at least one side panel comprises a chamfer at an upper edge thereof, the chamfer is adjacent the at least one central panel such that the at least one central panel is exposed above the chamfer.

29. A method of forming a carrier for holding at least one container, the carrier comprising:
obtaining a blank comprising a plurality of panels, the plurality of panels comprising a front panel, a back panel, at least one central panel, at least one side panel, and at least one bottom panel, the blank further comprising at least one divider flap foldably connected to one of the front panel and the back panel;
folding the plurality of panels at least partially around an interior of the blank; and
folding the at least one divider flap away from the one of the front panel and the back panel to form at least one opening in the one of the front panel and the back panel and such that the at least one divider flap extends through the interior of the carrier to the at least one central panel.

30. The method of claim 29, wherein the at least one opening provides access to the interior of the carrier.

31. The method of claim 29, wherein the at least one opening extends at least partially into the at least one side panel.

32. The method of claim 29, wherein the at least one divider flap is a first divider flap and the carrier further comprises a second divider flap foldably connected to the one of the front panel and the back panel, the second divider flap extends from the one of the front panel and the back panel to the at least one central panel, the at least one opening is a first opening, and the second divider flap is folded away from the one of the front panel and the back panel to form a second opening in the one of the front panel and the back panel.

33. The method of claim 32, wherein the first opening is in communication with the second opening.

34. The method of claim 33, wherein an attachment flap is foldably connected to each of the first divider flap and the second divider flap.

35. The method of claim 29, wherein the at least one side panel is a first front side panel and the plurality of panels further comprises a second front side panel, a first back side panel, and a second back side panel.

36. The method of claim 35, wherein the at least one divider flap is a first divider flap foldably connected to the back panel and the carrier further comprises a second divider flap foldably connected to the back panel and extending to the at least one central panel, the carrier further comprises a third divider flap and a fourth divider flap each foldably connected to the at least one central panel and extending to the front panel.

37. The method of claim 29, wherein at least one of the front panel and the back panel comprises at least one notch at an upper edge thereof, the at least one notch provides an access path to a portion of the at least one central panel aligned with the at least one notch.

38. The method of claim 37, wherein the at least one notch is a first notch at an upper edge of the front panel and the access path is a first access path, and the back panel comprises a second notch at an upper edge thereof that provides a second access path to a portion of the at least one central panel aligned with the second notch.

39. The method of claim 38, wherein the at least one central panel comprises a third notch at an upper edge thereof, and wherein in a folded configuration of the carrier, the first notch and the third notch are aligned such that the first access path extends through the third notch to a portion of the back panel.

40. The method of claim 39, wherein in the folded configuration of the carrier, the second notch and the third notch are aligned such that the second access path extends through the third notch to a portion of the front panel.

41. The method of claim 39, wherein the front panel comprises a fourth notch at an upper edge thereof, wherein in the folded configuration of the carrier the fourth notch provides a fourth access path to a portion of the central panel aligned with the fourth notch.

42. The method of claim 39, wherein the at least one side panel comprises a chamfer at an upper edge thereof, the chamfer is adjacent the at least one central panel such that the at least one central panel is exposed above the chamfer.

43. A system, comprising:
a first carrier comprising:
a plurality of panels extending at least partially around an interior of the first carrier, the plurality of panels comprising a front panel, a back panel, at least one central panel, at least one side panel, and at least one bottom panel; and
at least one divider flap foldably connected to one of the front panel and the back panel, the at least one divider flap folded away from the one of the front panel and the back panel to form at least one opening in the one of the front panel and the back panel, the at least one divider flap extends through the interior of the first carrier to the at least one central panel; and
a second carrier comprising a plurality of panels extending at least partially around an interior of the second carrier, at least one panel of the plurality of panels of the second carrier is positioned adjacent the one of the front panel and the back panel of the first carrier to cover the at least one opening of the first carrier.

44. The system of claim 43, wherein the at least one opening provides access to the interior of the first carrier.

45. The system of claim 43, wherein the at least one opening extends at least partially into the at least one side panel of the first carrier.

46. The system of claim 43, wherein the at least one divider flap is a first divider flap and the first carrier further comprises a second divider flap foldably connected to the one of the front panel and the back panel, the second divider flap extends from the one of the front panel and the back panel to the at least one central panel, the at least one opening is a first opening, and the second divider flap is folded away from the one of the front panel and the back panel to form a second opening in the one of the front panel and the back panel.

47. The system of claim 46, wherein the first opening is in communication with the second opening.

48. The system of claim 47, wherein an attachment flap is foldably connected to each of the first divider flap and the second divider flap.

49. The system of claim 43, wherein the at least one side panel is a first front side panel and the plurality of panels of the first carrier further comprises a second front side panel, a first back side panel, and a second back side panel.

50. The system of claim 49, wherein the at least one divider flap is a first divider flap foldably connected to the back panel and the first carrier further comprises a second divider flap foldably connected to the back panel and extending to the at least one central panel, the first carrier further comprises a third divider flap and a fourth divider flap each foldably connected to the at least one central panel and extending to the front panel.

51. The system of claim 43, wherein at least one of the front panel and the back panel comprises at least one notch at an upper edge thereof, the at least one notch provides an access path to a portion of the at least one central panel aligned with the at least one notch.

52. The system of claim 51, wherein the at least one notch is a first notch at an upper edge of the front panel and the access path is a first access path, and the back panel comprises a second notch at an upper edge thereof that provides a second access path to a portion of the at least one central panel aligned with the second notch.

53. The system of claim 52, wherein the at least one central panel comprises a third notch at an upper edge thereof, and wherein in a folded configuration of the first carrier, the first notch and the third notch are aligned such that the first access path extends through the third notch to a portion of the back panel.

54. The system of claim 53, wherein in the folded configuration of the first carrier, the second notch and the third notch are aligned such that the second access path extends through the third notch to a portion of the front panel.

55. The system of claim 53, wherein the front panel comprises a fourth notch at an upper edge thereof, wherein in the folded configuration of the first carrier the fourth notch provides a fourth access path to a portion of the central panel aligned with the fourth notch.

56. The system of claim 53, wherein the at least one side panel comprises a chamfer at an upper edge thereof, the chamfer is adjacent the at least one central panel such that the at least one central panel is exposed above the chamfer.

57. The system of claim 43, wherein
the plurality of panels of the second carrier comprises a front panel, a back panel, at least one central panel, at least one side panel, and at least one bottom panel, and
at least one divider flap is foldably connected to one of the front panel and the back panel of the second carrier, the at least one divider flap of the second carrier is folded away from the one of the front panel and the back panel of the second carrier to form at least one opening in the one of the front panel and the back panel of the second carrier, the at least one divider flap of the second carrier extends through the interior of the second carrier to the at least one central panel of the second carrier,
the system further comprises an outer carton and the first carrier and the second carrier are at least partially inserted into an interior of the outer carton, the at least one opening of the second carrier is positioned adjacent a portion of the outer carton such that the portion of the outer carton covers the at least one opening of the second carrier.
